(19) United States
(12) Patent Application Publication
(10) Pub. No.: US 2015/0298260 A1
(43) Pub. Date: Oct. 22, 2015

(54) METHOD AND SYSTEM FOR MARKING A SURFACE BY LASER TREATMENT

(71) Applicant: AKEO PLUS, Chateau-Gaillard (FR)

(72) Inventor: Stephane MOREL, Les Moussieres (FR)

(21) Appl. No.: 14/646,928

(22) PCT Filed: Nov. 26, 2013
(86) PCT No.: PCT/FR2013/052853

§ 371 Date: May 22, 2015

(30) Foreign Application Priority Data
Nov. 26, 2012 (FR) 12/61241

(51) Int. Cl. B23K 26/36; B23K 26/04; G05B 19/4097; B23K 26/08

(52) U.S. Cl. CPC B23K 26/365; B23K 26/0884; B23K 26/041; G05B 19/4097; G05B 2219/45212; G05B 2219/45165

(57) ABSTRACT

The invention concerns a method for marking a surface (S) by laser treatment, consisting of etching a plurality of patterns (M(0), M(1)) onto the surface by means of a laser source (2), said patterns being distributed across the surface according to a predefined tessellation of adjacent patterns, which involves: —etching each pattern from a corresponding virtual image generated in an image plane (20) of the laser source and physically reproduced by laser etching on the surface, in which each virtual image defines a frame physically reproduced on an area of the surface such that the corresponding etched pattern has an etched frame covering said area, the etched frames of adjacent patterns covering adjacent areas; and —the laser source is controlled in position between each etching of a pattern by means of a three-dimensional surface mapping system (3) coupled to the laser source; the method being remarkable in that it involves resetting the laser source, before etching each pattern, by matching up hook elements and target elements between adjacent patterns. The present invention is applicable in the field of etching items made from a material suitable for laser marking.

### TECHNICAL FIELD

The present invention relates to a method for marking a surface by laser treatment, consisting of etching a plurality of patterns onto the surface by means of a laser source, said patterns being distributed on the surface according to a predefined tessellation of adjacent patterns.

The invention applies to the field of marking pieces in a matter suitable for laser marking, in other words of any type liable to be etched by a laser treatment.

In a specific but non limiting application, the invention is applicable for marking pieces of large dimensions, such as for example dashboards or the trims of automotive vehicle doors, pieces of trim or fitting up in the aeronautics field, pieces of the cowl, for covering or protecting electronic, medical apparatuses, etc.

### BACKGROUND

Currently, it is observed a search for geometrical patterns marked on the more complex and delicate pieces, substantially for aesthetic reasons, imposing the implementation of digital techniques for driving the laser source which will carry out the required etching.

Thus, it is known to implement marking methods in which:
each pattern is etched based on a corresponding virtual image generated in an image plane of the laser source and physically reproduced by laser etching on the surface, where each virtual image defines a frame physically reproduced on an area of the surface in such a manner that the corresponding etched pattern has an etched frame covering said area, the etched frames of the adjacent patterns covering adjacent areas; and
the laser source is driven in position between each etching of a pattern by means of a three-dimensional mapping system of the surface coupled to the laser source.

The difficulty of such a method is due to the necessary precision to be provided to each etching of a pattern, the laser source being displaced between each etched pattern. In fact, it is essential that the patterns be glued together, otherwise holes and/or discontinuities and/or overlaps would become apparent between the frames of the different patterns, thus being detrimental to the global aesthetic aspect of the surface marking. It is generally referred to as local pattern mismatching defects.

Such local defects find their origins substantially in the limits of the three-dimensional mapping system and in the limits of the automaton (generally a robot with five or six axes) which ensures the displacement and orientation of the laser source, which entail relative uncertainties of positioning between the patterns.

Furthermore, it is current to seek for precisions of the order of 2 to 5 micrometers, according to the quality of the laser source. However, such a level of precision proves to be extremely difficult when the marking focuses on several thousand patterns to be etched, on lengths of the order of the meter, or even several meters, and with an automaton which drives the displacement and orientation of the laser source with a precision generally of the order of 0.2 to 0.5 millimeters. In fact, the imprecision of the automaton inevitably induces continuity issues between the patterns etched as the marking takes place, especially on important lengths where it is noted that the error adds up and becomes unacceptable at the end of the marking.

To these difficulties are also added the errors generated by the computer assisted production computation which brings its share of imprecision, and the shape defects of the surface to be treated which is generally different from the theoretical three-dimensional model which acts as base for the computing of the laser source route.

### BRIEF SUMMARY

The purpose of the present invention is to propose a method for marking a surface by laser treatment which allows readjusting the laser source, and more specifically to optically readjust the image plane of the laser source, prior to each etching of a pattern, in order to ensure in the end a proper matching of the patterns.

To this end, it proposes a method for marking a surface by laser treatment, consisting of etching a plurality of patterns on the surface by means of a laser source, said patterns being distributed on the surface according to a predefined tessellation of adjacent patterns, in which:
each pattern is etched based on a corresponding virtual image generated in an image plane of the laser source and physically reproduced by laser etching onto the surface, where each virtual image defines a virtual frame physically reproduced on an area of the surface in such a manner that the corresponding etched pattern has an etched frame covering said area, the etched frames of the adjacent patterns covering adjacent areas; and
the laser source is driven in position between each etching of a pattern by means of a three-dimensional mapping system of the surface coupled to the laser source;

said method being characterized in that it comprises the following steps:

a) a prior theoretical modelization of the tessellation of the patterns is achieved on the surface based on a three-dimensional surface model, said modelization consisting in computing the shapes and positions of a plurality of virtual images ensuring the tessellation of this three-dimensional model by adjacent virtual images as well as a concatenation given in the physical reproduction of the virtual images, each virtual image defining:
a virtual frame,
virtual elements called fastening elements located inside said virtual frame, and
virtual elements called target elements located outside said virtual frame, where the positions of the virtual target elements and the virtual fastening elements relatively to the corresponding virtual frames are computed so that the set of virtual target elements of a virtual image coincides on the three-dimensional model with virtual fastening elements of the adjacent virtual images, and so that the set of virtual fastening elements of a virtual image coincide on the three-dimensional model with virtual target elements of the adjacent virtual images;

b) it is calculated, for each virtual image, an orientation and a position of the laser source relatively to the surface for allowing the implementation of the etching of the patterns in accordance with the prior theoretical modelization;

c) it is etched a pattern called start pattern, based on a virtual image, of a called start orientation and position of the laser source from computations of the steps a) and b), the start pattern having an etched frame covering an area called start area of the surface, etched target elements located outside the etched frame of the start pattern and hence outside said start area;

d) it is prepared the etching of a new pattern on a new area adjacent to said start area, by generating a new virtual image and by displacing and orienting the laser source in accordance with the computations of steps a) and b), some of the target elements of the start pattern being etched on said new area;

e) it is identified with the three-dimensional mapping system the positions of the target elements of the start pattern etched on said new area;

f) the projections are computed, in the image plane of the laser source, of the target elements of the start pattern etched on the new area;

g) it is applied, in the image plane, a geometric transformation on the new virtual image to make coincide:
said projections of the target elements of the start pattern, with
the virtual fastening elements of the new virtual image which were initially computed during the step a), in order to coincide with virtual target elements of the virtual start image;

h) the new pattern is etched from the new virtual image transformed during the step g), in such a manner that the new pattern has an etched frame covering the new area, etched fastening elements which coincide with the target elements of the start pattern etched on said new area, and etched target elements located outside the new area;

i) steps d) to h) are repeated for the following patterns in order to tessellate the surface with adjacent etched patterns.

Thus, the method according to the invention includes prior computation steps a) and b) (steps called pre-computation or preprocessing which substantially consist in virtually modelizing the tessellation (defining the shapes and positions of the virtual images, defining the sequence or the etching order between the patterns, defining the positions and orientations of the laser source with each etching). However, if this modelization is directly implemented, without taking into account the reality of the etching and the position of the laser source before etching, there are risks of creating local defects, whence the necessity of optically readjusting the image plane of the laser source before each etching.

For that, the invention proposes to define virtual fastening elements and virtual target elements which will serve to readjust the image plane of the laser source, by implementing a transformation (in other words a correction) on the new virtual image (step g)) for ensuring in the end that the concerned fastening elements and target elements coincide, thus allowing to rectify the errors of positioning and orientation of the laser source, the real defects on the surface non anticipated in the three-dimensional surface model, etc: such a readjustment being in the end independent from the length or dimension of the surface to be marked.

According to a feature, during computations of step a), each virtual image is computed in such a manner that the virtual fastening elements thereof are localized on virtual texture elements of its virtual frame, said virtual texture elements defining the drawing of the virtual frame, so that, during step h), the target elements of the start pattern etched on the new area are etched on texture elements of the etched frame of the new pattern.

In this manner, the target elements and the fastening elements are etched on texture elements, and they are thus concealed by these texture elements and perfectly integrated to the final marking texture, without harming the aesthetic aspect. These target and fastening elements will have served to carry out the readjustment, and they then disappear in the texture.

According to another feature, the method further comprises, prior to step c), two calibration steps:
a first step of calibrating a three-dimensional mapping system in order to be able to determine the position in space of a point of the surface,
a second step of calibrating the laser source with respect to the three-dimensional mapping system in order to be able to establish the projection, in the image plane of the laser source, of a point of the surface detected by the three-dimensional mapping system.

These calibration steps allow determining the mathematical computation tools necessary for implementing step f) which, as a reminder, consists in projecting the target elements of the start pattern (real etched elements in a three-dimensional space) in the image plane of the laser source (in other words in a two-dimensional space in which the new virtual image is found).

In a particular embodiment, the second calibration step consists in using the three-dimensional mapping system coupled to the laser source as follows:
it is etched on a planar surface, located at a first height, a plurality of calibration patterns based on a virtual image composed of a plurality of virtual calibration patterns distributed according to a given sizing, then it is determined with the three-dimensional mapping system the position of the calibration patterns etched on said planar surface;
the previous step is repeated on planar surfaces located at different heights with respect to said first height.

In this manner, a calibration is achieved at different heights (calibration in z) by using calibration patterns sequenced according to a predefined geometric sizing (calibration in x and y) and which are, preferably, easily recognizable by the mapping system. Thus, the correspondences are established between the three-dimensional space (in x, y and z) and the image plane of the laser source, for computing in the end a set of projection matrices (or change in frame of reference) between the three-dimensional space observed by the three-dimensional mapping system and the image plane in which the virtual images are generated before etching.

In a particular embodiment, the method uses, as a three-dimensional mapping system, at least one stereoscopic vision system comprising at least two cameras coupled to the laser source.

Such a stereoscopic vision system is particularly advantageous for mapping the surface in a precise manner.

Advantageously, the first step of calibrating the stereoscopic vision system implements an intrinsic calibration and an extrinsic calibration of the at least two cameras, then a stereoscopic calibration for determining the relative position and orientation of the cameras.

Thus, the relative position and orientation of the of the cameras and laser source may be known in an absolute frame of reference of Cartesian workspace, and the position of a point in the three-dimensional space may be determined in various known ways by triangulation techniques.

According to a possibility of the invention, the method uses, as three-dimensional mapping system, at least one system included in the following list: depth sensor, measuring system by projection of structured light fringes, 3D camera.

Preferably, this or these systems come as a complement of the stereoscopic vision system, in order to reinforce the detection of the points of the surface in the three-dimensional space.

It is also to be considered to employ specific lighting means (eg. UV, IR, visible) in order to improve the contrast on the surface to be treated and hence increase the precision of the three-dimensional mapping.

According to another possibility of the invention, during computations of step a), at least one virtual image includes a virtual frame called composite which is composed of a plurality of tessellation sub-elements gathered against each other.

The advantage of this technique, called gathering or patch, allows maximizing the etched surface area at each etching, and thus decreases the period of the marking operation; the tessellation sub-elements being sized and oriented in particular according to the morphology of the area on which they are provided to be etched. The target and fastening elements are then respectively computed outside and inside the gathering of the tessellation sub-elements.

In an advantageous manner, the virtual composite frame is based on the gathering of several polygonal tessellation sub-elements of a planar shape, said tessellation sub-elements preferably being gathered in order to fill at the maximum the surface area of the image plane of the laser source.

This gathering consists in generating a polygonal model, based on polygonal tessellation sub-elements, from a surface model in order to maximize the surface of the frame at each etching according to the morphology of the related area of the surface to be treated.

Preferably, the polygonal tessellation sub-elements are gathered according to a triangulation model using a criterion called chord error.

The chord error conditions the number of polygonal tessellation sub-elements of the polygonal triangulation model. The lower the chord error, the more coherent and precise the polygonal model is, but the higher the number of polygonal tessellation sub-elements. Thus, it becomes necessary to arbitrate between the number of polygonal tessellation sub-elements and the geometric fineness.

The invention also relates to a system for marking a surface by laser treatment, suitable for implementing a marking method in accordance with the invention, said system including:
a laser source provided with an image plane;
a three-dimensional mapping system coupled to the laser source;
a system for generating a virtual image in the image plane of the laser source, suitable for generating a virtual image;
an actuating system ensuring the displacement and orientation of the laser source and the three-dimensional mapping system;
a computation system designed to achieve the steps of computation a), b) and f), and apply the geometric transformation of the step g) on the new virtual image.

### BRIEF DESCRIPTION OF THE DRAWINGS

Other features and advantages of the present invention will become apparent upon reading the following detailed description, of a non-limiting implementation embodiment, made with reference to the accompanying figures in which:

FIGS. 1 and 2 are perspective schematic views of a marking system in accordance with the invention;

FIGS. 3a to 3d schematically illustrate the steps of etching a start pattern on a start area of the surface, where:

FIG. 3a is a schematic view of the three image planes (image plane of the first camera, image plane of the laser source, image plane of the second camera) during the generation of the virtual start image, prior to etching;

FIG. 3b is a schematic view of the marking system occupying a start position and orientation, and achieving the etching of the start pattern based on the virtual start image;

FIG. 3c is a partial schematic view of the surface on which the start pattern is etched;

FIG. 3d is a schematic view of the three image planes after the etching of the start pattern;

FIGS. 4a to 4h schematically illustrate the steps of etching a new pattern on the surface, in a manner adjoining to the start pattern, where:

FIG. 4a is a schematic view of the marking system occupying a new position and a new orientation for the preparation of the etching of the new pattern on a new area adjacent to the start area;

FIG. 4b is a schematic view of the surface on which the start pattern is etched and the new area is illustrated in a dashed line;

FIG. 4c is a schematic view of the three image planes during the generation of the new virtual image;

FIG. 4d is a schematic view of the three image planes after the at least partial projection of the start pattern in the image plane of the laser source, in order to allow achieving the readjusting of the laser source;

FIG. 4e is a schematic view of the three image planes after the transformation of the new virtual image for the readjustment of the laser source;

FIG. 4f is a schematic view of the marking system achieving the etching of the new pattern from the new transformed virtual image;

FIG. 4g is a schematic view of the surface on which the start pattern and the new pattern are etched;

FIG. 4h is a schematic view of the three image planes after etching the new pattern;

FIGS. 5a to 5d schematically illustrate steps of constructing a virtual image by gathering polygonal tessellation sub-elements according to a triangulation model;

FIG. 6 is a schematic view of the marking system during the second step of calibrating the laser source with respect to the three-dimensional mapping system.

### DETAILED DESCRIPTION

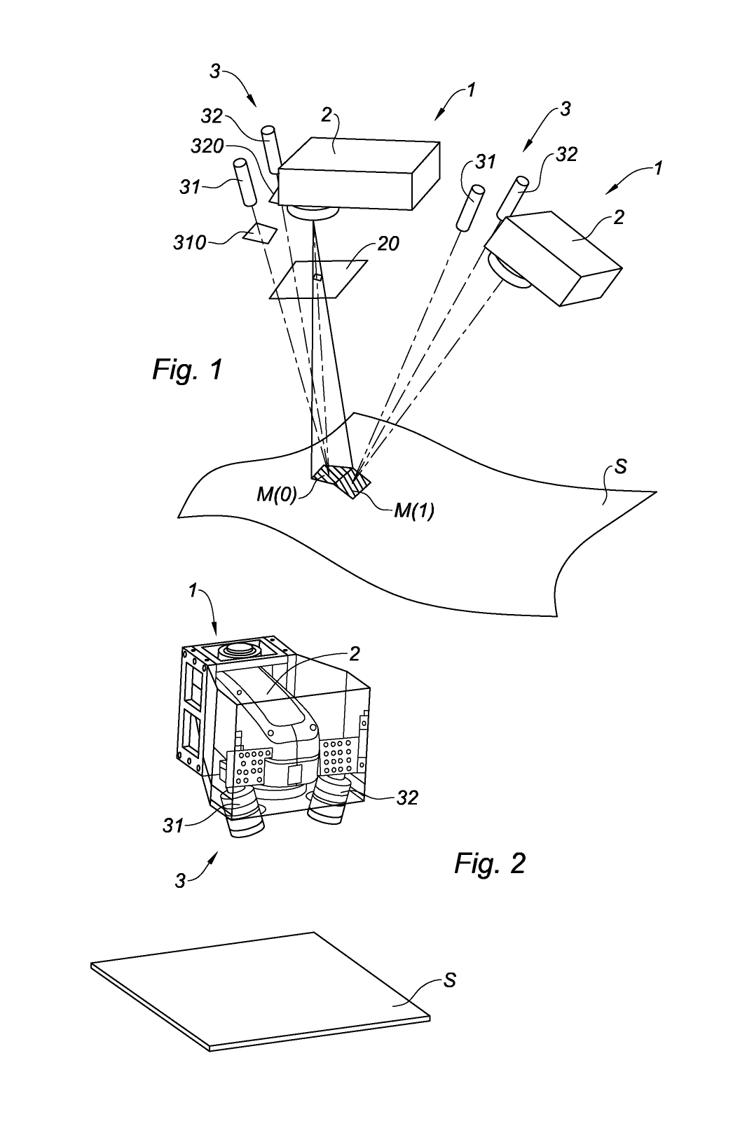

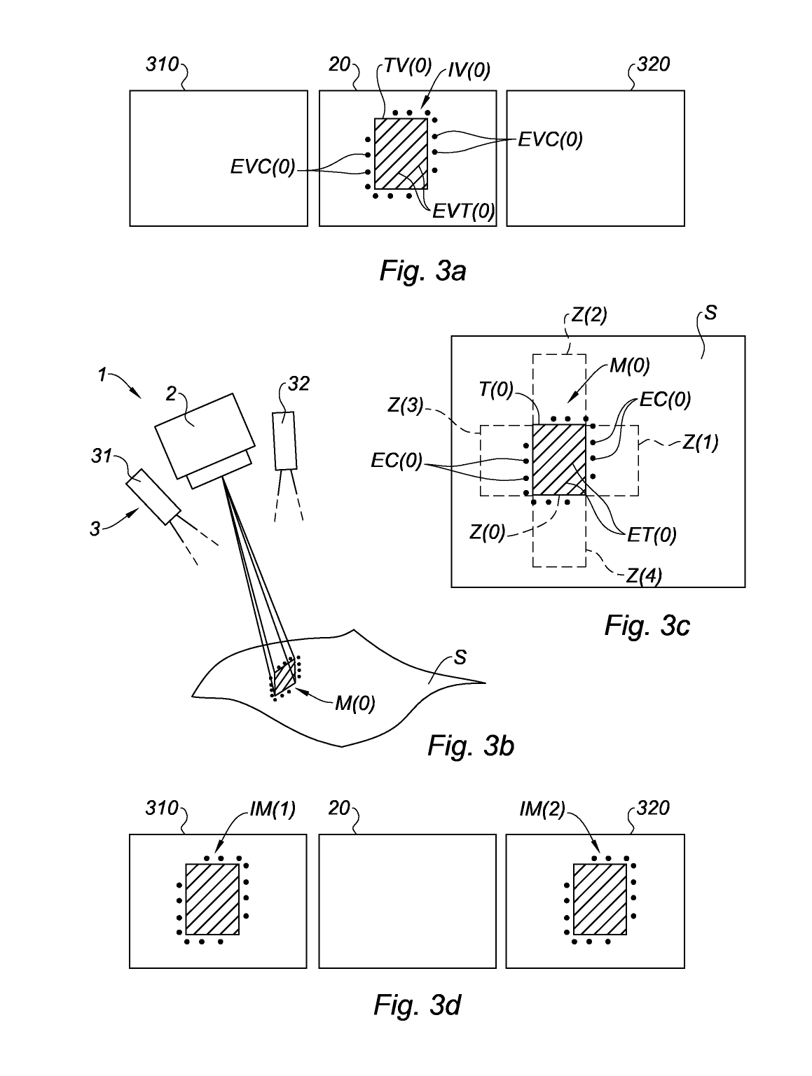

In reference to FIGS. 1 and 2, a marking system 1 of a surface S in compliance with the invention includes:
a laser source 2, otherwise called laser scanner, suitable for physically reproducing on the surface S by laser etching a virtual image generated in a so-called laser image plane 20;
a three-dimensional mapping system 3 coupled to the laser source 2 and suitable for a scanning the surface S in three dimensions, the laser source 2 and the three-dimensional mapping system 3 being securely coupled and hence secured rotationally and in displacement;
a system (non illustrated, as integrated to the laser source 2) for generating a virtual image in the image plane of the laser source;
an actuating system (non illustrated) ensuring the displacement and orientation of the laser source 2 and the three-dimensional mapping system 3, in particular of the type robot with five or six axes;
a computation system (non illustrated), of the control unit type, suitable for achieving the computations detailed hereinafter, and for controlling the laser source, the three-dimensional mapping system 3, the generation system and the driving system.

As illustrated on FIGS. 1 and 2, the three-dimensional mapping system 3 includes a stereoscopic vision system comprising:
at least two cameras 31, 32 each designed for recording at least one image of the surface S in a corresponding image plane 310, 320, each camera 31, 32 being associated to at least one coordinate allowing to deduce the relative position of the cameras 31, 32; and
computation means connected to the cameras 31, 32 and designed for constituting a three-dimensional representation of the surface S by means of an evaluation in stereovision of the images from cameras 31, 32 and based on the relative position of the cameras.

In complement or replacement of the stereoscopic vision system 3, it is to be considered to provide at least one three-dimensional mapping system included in the following list: depth sensor, measuring system by projecting structured light fringes, measuring system by projection of laser fringes, 3D camera.

In accordance with the invention, the marking method using such a marking system 1, consists in etching on the surface S a plurality of patterns M(i) by means of a marking system 1, with patterns M(i) distributed on the surface S according to a predefined tessellation of adjacent patterns.

More particularly, each pattern M(i) is etched from a corresponding virtual image IV(i) generated in the laser image plane 20 of the laser source 2, where each virtual image IV(i) defines a virtual frame TV(i) physically reproduced on an area Z(i) of the surface S such that the corresponding etched pattern M(i) has an etched frame TG(i) covering said area Z(i), the etched frames TG(i) of the adjacent patterns M(i) covering adjacent areas Z(i).

First, the marking method implements prior computation steps (steps called pre-computation or preprocessing steps).

In a first step a) of pre-computation, it is achieved a prior theoretical modelization of the tessellation of patterns M(i) on the surface S based on a three-dimensional surface model (theoretical surface), said modelization consisting in computing the shapes and positions of a plurality of virtual images IV(i) ensuring the tessellation of this three-dimensional model by adjacent virtual images IV(i), as well as a concatenation given in the physical reproduction of the virtual images IV(i).

The purpose of this step a) is to compute beforehand all the parameters of the virtual images IV(i) (shape, localization, order in the sequence) for tessellating the three-dimensional surface model, these virtual images IV(i) then being reproduced by etching on the real surface S in the form of a tessellation of patterns M(i). However, between the theoretical modelization and reality, distortions and errors appear which require readjusting the laser source between each etching of a pattern M(i).

Each virtual image IV(i) defines:
a virtual frame TV(i) which has virtual texture elements EVT(i), such as for example straight lines, curves, etc. which define the drawing of the virtual image IV(i);
so-called virtual fastening elements EVA(i) located inside the virtual frame TV(i); and
so-called virtual target elements EVC(i) located outside the virtual frame TV(i).

The virtual image TV(i) is physically reproduced by laser etching on an area Z(i) of the surface S, in the form of a pattern M(i) which has:
an etched frame T(i) which has texture elements ET(i), such as for example straight lines, curves, etc. which define the drawing of the pattern M(i);
fastening elements EA(i) etched and located inside the frame T(i) and hence the area Z(i); and
target elements EC(i) etched and located outside the frame T(i) and hence outside the area Z(i), that is to say in the periphery of the area Z(i) on areas Z(j) directly adjacent or adjoining to the area Z(i).

For the rest of the description, and as illustrated on the figures, the so-called virtual fastening elements EVA(i) and the so-called virtual target elements EVC(i) are achieved in the form of points, respectively called virtual fastening points EVA(i) and virtual target points EVC(i); thus physically translating by fastening elements EA(i) and target elements EC(i) etched in the form of points, respectively called fastening points EA(i) and target points EC(i). Obviously, the virtual fastening elements EVA(i) and the virtual target elements EVC(i) may have other shapes (cross, circle, ellipse, triangle, etc.), in such a manner that the corresponding fastening elements EA(i) and target elements EC(i) may have other shapes.

Preferentially, in order to conceal in the etched texture (or frame) the fastening points EA(i) and the target points EC(i) of the patterns M(i), the virtual fastening points EVA(i) are localized on the virtual texture elements EVT(i) of the corresponding virtual frame TV(i).

With virtual frames TV(i) of polygonal shape, delimited by successive sides, it is advantageous to have at least two virtual target points EVC(i) per side, thus corresponding to at least two virtual fastening points EVA(i) per side.

The positions of the virtual target points EVC(i) and the virtual fastening points EVA(i) relatively to their corresponding virtual frames TV(i) are computed so that:
the set of virtual target points EVC(i) of a virtual image IV(i) coincide on the three-dimensional model with virtual fastening points EVA(j) of the virtual images IV(j) adjacent to said virtual image IV(i), and
the set of virtual fastening points EVA(i) of a virtual image IV(i) coincide on the three-dimensional model with virtual target points EVC(j) of the virtual images IV(j) adjacent to said virtual image IV(i).

Thus, the principle is to etch, for each pattern M(i), target points EC(i) on the areas Z(j) adjacent to the corresponding area Z(i); these target points EC(i) serving as reference for optically readjusting the laser source 2 during the etching of the adjacent patterns M(j).

In a second step b) of pre-computation, for each virtual image IV(i) is computed, an orientation and position of the laser source 2 relatively to the surface S in order to allow the implementation of the etching of the patterns M(i) in accordance with the theoretical modelization computed beforehand during step a).

Thus, following steps a) and b) of pre-computation, the etching may be launched, the etching of each pattern M(i) being substantially defined by:

shape and position of the virtual image IV(i), order in the etching sequence, orientation and position of the laser source 2.

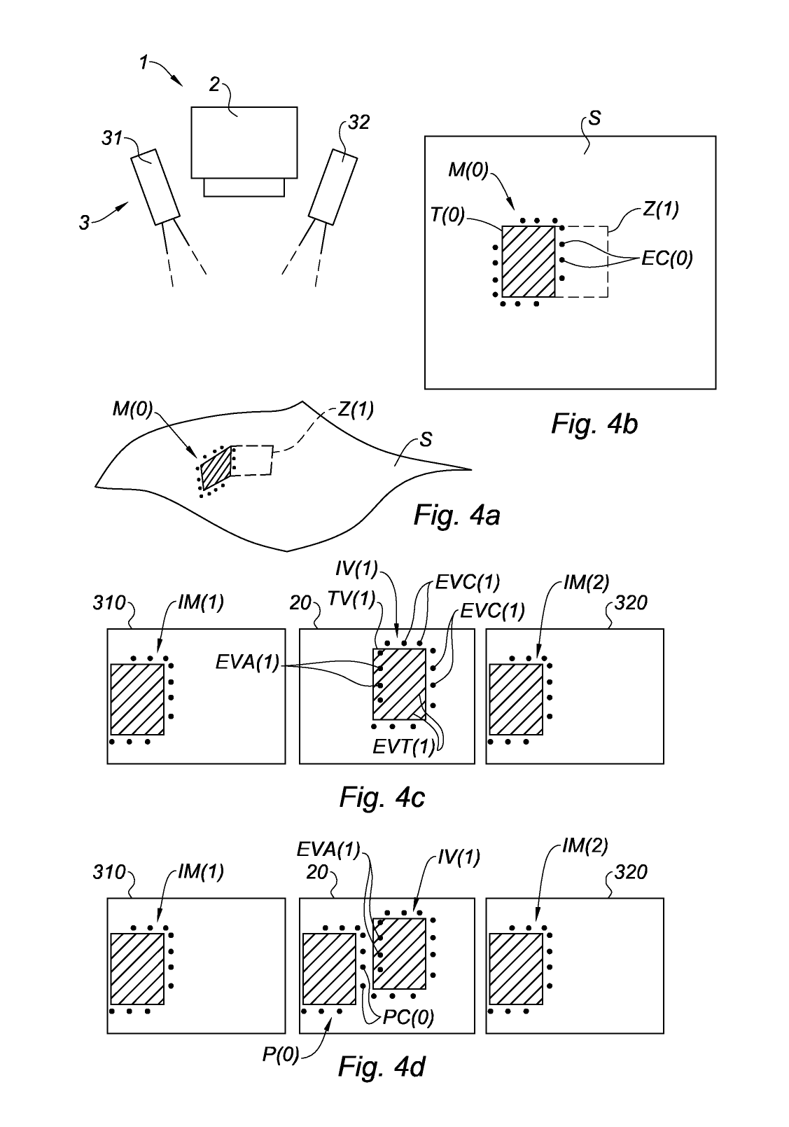

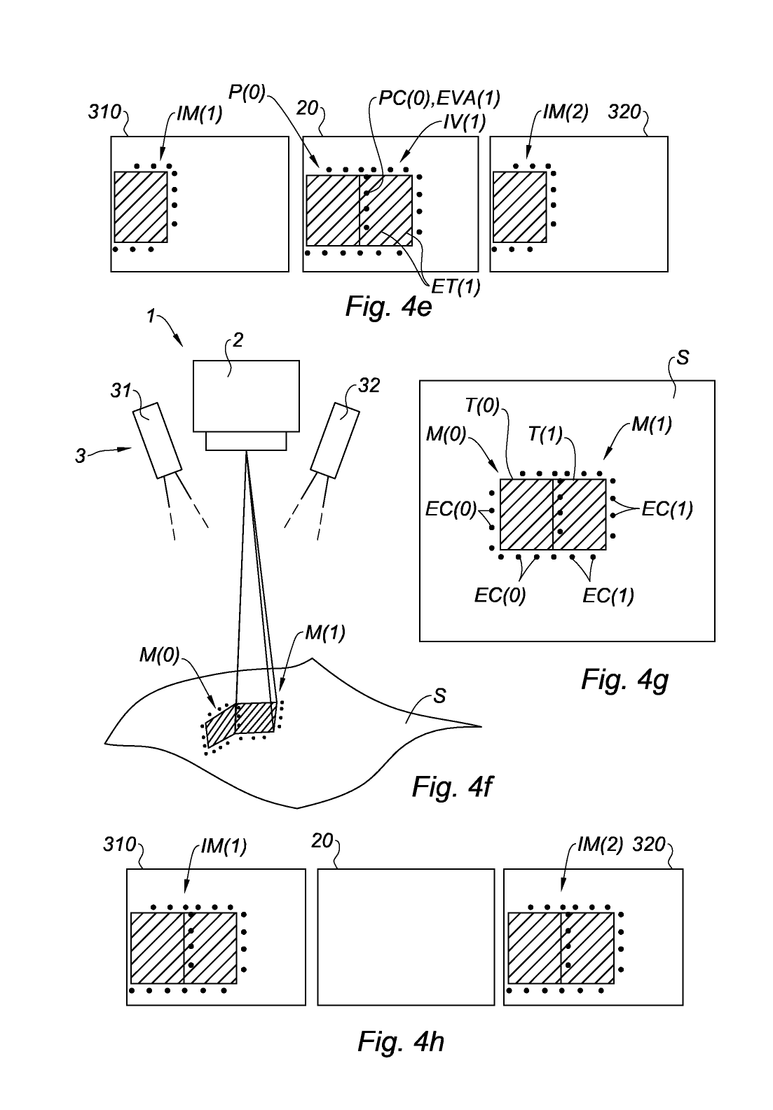

In reference to FIGS. 3 and 4, the rest of the description focuses on the actual etching, with the intermediate steps of optical readjusting of the laser source 2.

In reference to FIGS. 3a to 3d, the method includes a step c) of etching a start pattern M(0) from a virtual start image IV(0), in which:
in the laser image plane 20, the virtual start image IV(0) (see FIG. 3a) from the step a) of pre-computation is generated, this virtual start image IV(0) having a virtual frame TV(0) inscribed in a rectangle and defined by virtual texture elements EVT(0) composed of parallel virtual lines, and virtual target points EVC(0) disposed outside the virtual frame TV(0) (the virtual fastening points here being absent, as the fastening points are useless for the start pattern);
the laser source 2 is positioned and oriented in accordance with the pre-computation step b), in order to allow the etching on a start area Z(0) of the surface (see FIG. 3b);
the start pattern M(0) is etched on the start area Z(0), (see FIGS. 3b and 3c), the start pattern M(0) having an etched frame T(0) covering the rectangular start area Z(0), with texture elements ET(0) composed of parallel lines, and etched target points EV(0) located outside the etched frame T(0) and hence outside the start area Z(0).

Thus, the target points EC(0) of the start pattern M(0) are etched on areas Z(1), Z(2), Z(3), Z(4) adjacent to the start area Z(0), new patterns M(1), M(2), M(3), M(4) being provided to be etched afterwards on these adjacent areas Z(1), Z(2), Z(3), Z(4).

FIG. 3d illustrates the images IM(1) and IM(2) of the first 31 and second 32 cameras, taken in their respective image planes 310, 320, after etching the start pattern M(0).

FIGS. 4a to 4h illustrate the etching of a new pattern M(1) on the area Z(1) adjacent to the start area Z(0).

For this, the method includes a step d) of preparing the etching of the new pattern M(0) on this new area Z(1) adjacent to the start area Z(0), which consists in:
positioning and orienting the laser source 2 in accordance with the pre-computation step b), in order to allow the etching on this new area Z(1) (see FIG. 4a), some of the target points EC(0) of the start pattern M(0) being etched on this new area Z(1) (see FIG. 4b);
a new virtual image IV(1) is generated in accordance with the computations of the step a) (see FIG. 4c).

This new virtual image IV(1) has:
a virtual frame TV(1) inscribed in a rectangle and defined by virtual texture elements EVT(1) composed of parallel virtual lines;
virtual target points EVC(1) disposed outside the virtual frame TV(1), except on the side of the start area Z(0), and
virtual fastening points EVA(1) disposed inside the virtual frame TV(1) and theoretically provided to coincide, after etching, with the target points EC(0) of the start pattern M(0) etched on the new area Z(1).

Then, a step e) of detection is carried out with the cameras 31, 32 of the stereoscopic vision system 3, of the positions of the target points EC(0) of the start pattern M(0) etched on the new area Z(1) (see images IM(1) and IM(2) on FIGS. 4c and 4d).

Then, a step f) of computing the projections PC(0) is carried out, in the laser image plane 20 of the laser source 2, of the target points EC(0) of the start pattern M(0) etched on the new area Z(1) (see FIG. 4d). In other words, a transformation of the three-dimensional space (the target points EC(0) etched on a three-dimensional surface S) is conducted towards a two-dimensional space (the projections P(0) in the laser image plane 20); by noting that the three-dimensional localization of the target points EC(0) is obtained by stereoscopic reconstruction based on images IM(1), IM(2) from cameras 31, 32.

In general, it is computed a projection P(0) of the elements etched on the surface based on images IM(1), IM(2) from cameras 31, 32, and among these etched elements there are the interesting target points EC(0). In other words, the positions in space of the elements etched on the surface S are recovered in the vicinity of the new area Z(1), based on images IM(1), IM(2), then, in the laser image plane 20 these etched elements viewed by the cameras 31, 32 are projected thus forming a projection P(0) in this laser image plane 20; this projection P(0) comprising the projections PC(0) of the target points EC(0) in the new area Z(1).

If there had not been any distortion or imprecision, there should have been the projections PC(0) of the target points EC(0) coincident with the virtual fastening points EVA(1). In the example of FIG. 4d, it is to be noted that the projections PC(0) do not coincide with the virtual fastening points EVA(1), in such a manner that a readjusting of the laser source 2 is to be achieved.

This step g) of readjusting consists in applying, in the laser image plane 20, a geometric transformation (rotation, translation, deformation) on the new virtual image IV(1) (see FIG. 4e) in order to make coincide:
the projections PC(0) of the target points EC(0) of the start pattern M(0) etched on the new area Z(1), with
the virtual fastening points EVA(1) of the new virtual image IV(1).

In the example of FIGS. 4d and 4e, only a translation of the new virtual image IV(1) has been necessary in order to make the projections PC(0) coincide with the virtual fastening points EVA(1).

Once this readjustment carried out, it may be achieved the step h) of etching the new pattern M(1) based on the new virtual image IV(1) transformed or corrected during the step g) (see FIGS. 4f and 4g), in such a manner that the new pattern M(1) has:
an etched frame T(1) covering the new area Z(1);
etched fastening points EA(1) which coincide with the target points EC(0) of the start pattern M(0) etched on the new area Z(1); and
etched target elements EC(1) located outside the new area Z(1), except on the start area Z(0).

As a reminder, the fastening points EA(1) are localized on the texture elements ET(1) of the frame T(1), in such a manner that the target points EC(0) are concealed in the texture of the new pattern M(1) (on FIGS. 3 and 4, the target and fastening points are oversized with respect to the texture lines in order to facilitate the comprehension of the figures).

The steps d) to h) for the following patterns M(2), . . . M(N) are repeated in order to tessellate the surface with adjacent etched patterns, by considering each etched pattern as a potential start pattern for the etching of a new pattern; it being specified that the last pattern M(N) to be etched has no target points.

Prior to the etching step c), the method also provides:
a first step of calibrating the stereoscopic vision system 3, with an intrinsic calibration and an extrinsic calibration of the two cameras 31, 32 followed by a stereoscopic calibration, in order to be able to determine the position in space of a point of the surface S; and
a second step of calibrating the laser source 2 with respect to the stereoscopic vision system 3 to be able to establish the projection, in the image plane 20 of the laser source 2, of a point of the surface detected by the stereoscopic vision system 3.

The second calibration step allows achieving the projection step f), in the laser image plane 20, of the points etched on the surface S, and particularly of the target points EC(i).

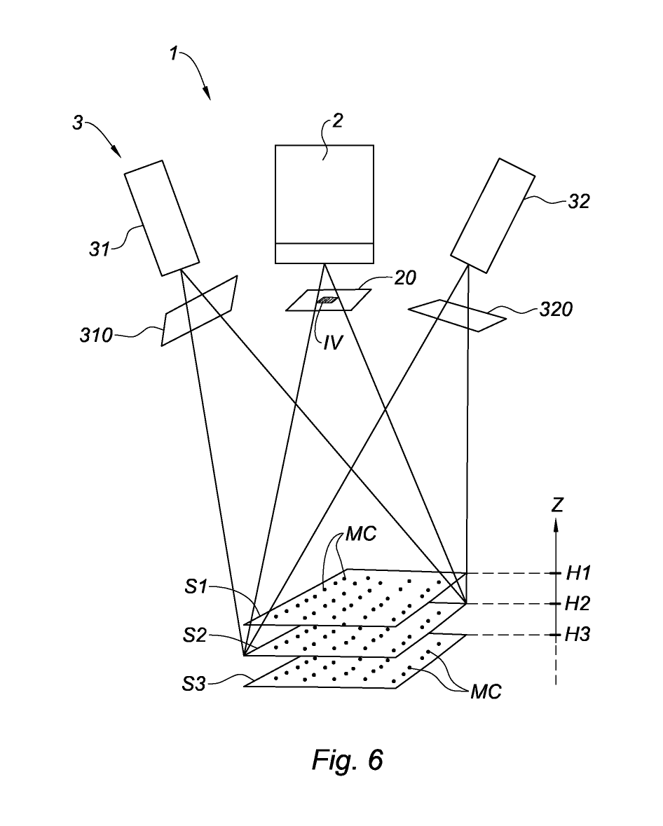

In reference to FIG. 6, this second calibration step consists in achieving the following steps:
on a planar surface S1, located at a first height H1, a plurality of calibration patterns MC (eg. A succession of points distributed in lines and columns) are etched based on a virtual calibration image IVC composed of a plurality of virtual calibration patterns distributed according to a given geometric sizing, then with the stereoscopic vision system 3, the position of the calibration patterns MC etched on the planar surface S1 are determined;
the previous step is repeated on planar surfaces S2, S3, etc. located at different heights H2, H3, etc. with respect to said first height H1.

In this manner, the correspondences between the real points etched on surfaces S, S1, S2, etc. and the points on the three image planes 20, 310, 320 may be established. By achieving these steps at different heights (or depths), the laser source 2 is strongly calibrated with respect to the stereoscopic vision system 3. The result of this second calibration step translates by a set of matrices of frame of reference change (in other words projection) between the three-dimensional space (measured thanks to cameras 31, 32) and the laser image plane 20.

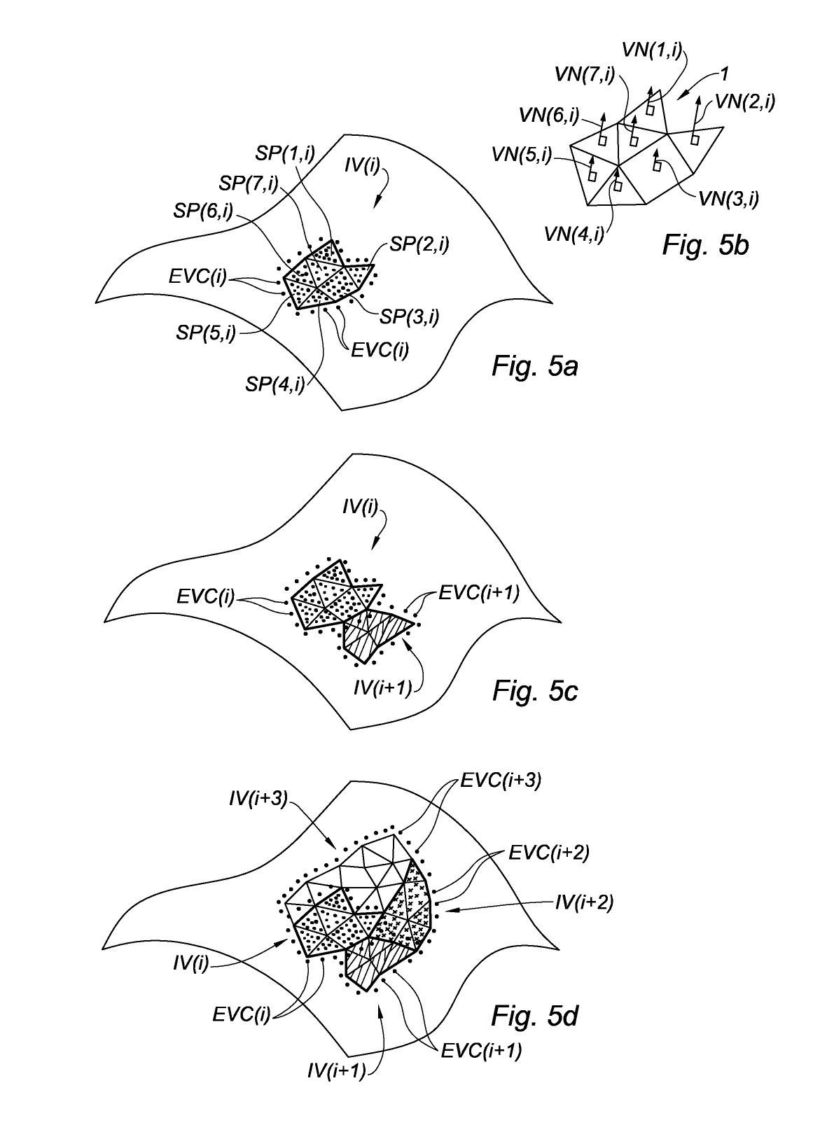

Furthermore and in reference to FIGS. 5a to 5d, it is to be considered to provide, during the step a) of pre-computation, that at least one or each virtual image IV(i) is computed according to a technique called gathering technique, in which the virtual image IV(i) has a virtual frame called composite which is composed of a plurality of tessellation sub-elements SP(k, i) gathered against each other.

By working from predefined tessellation sub-elements SP(k, i), the virtual frame TV(i) is constructed by gathering several tessellation sub-elements SP(k, i), by taking into consideration the three-dimensional morphology of the area Z(i) to be treated, and the virtual fastening points EVA(i) and the virtual target points EVC(i) are positioned once the gathering achieved.

As is visible on FIGS. 5a to 5d, it is to be considered to work with polygonal tessellation sub-elements SP(k, i) of planar shape, said tessellation sub-elements SP(k, i) preferably being gathered for filling at the maximum the surface area of the image pane of the laser source. Thus, there is mention of a conversion of a surface model (here the three-dimensional surface model) into a polygonal model.

In order to implement such a conversion, the use of a triangulation model is promoted using a criterion of chord error, which corresponds in a known manner to the allowed maximum distance between the plane of each polygonal tessellation sub-element and the three-dimensional surface model. In this case, it is to be considered to work on the normal vectors VN(k, i) to the respective tessellation sub-elements SP(k, i) (see FIG. 5b) and the tessellation sub-elements SP(k, i) are gathered by comparing the near normal vectors according to the retained fixed criterion (the chord error).

Obviously, the aforementioned implementation embodiment has no limiting characteristic and other improvements and details may be brought to the method according to the invention, without however departing from the scope of the invention where other forms may for example be achieved for the patterns.

1. A method for marking a surface by laser treatment, comprising:
etching a plurality of patterns on the surface by means of a laser source, said patterns being distributed on the surface according to a predefined tessellation of adjacent patterns, in which:
each pattern is etched based on a corresponding virtual image generated in an image plane of the laser source and physically reproduced by laser etching onto the surface, where each virtual image defines a virtual frame physically reproduced on an area of the surface in such a manner that the corresponding etched pattern has an etched frame covering said area, the etched frames of the adjacent patterns covering adjacent areas; and
the laser source is driven in position between each etching of a pattern by means of a three-dimensional mapping system of the surface coupled to the laser source;
said method being characterized in that it comprises the following steps:
a) a prior theoretical modelization of the tessellation of the patterns is achieved on the surface based on a three-dimensional surface model, said modelization consisting in computing the shapes and positions of a plurality of virtual images ensuring the tessellation of this three-dimensional model by adjacent virtual images as well as a concatenation given in the physical reproduction of the virtual images, each virtual image defining:
a virtual frame,
virtual elements called fastening elements located inside said virtual frame, and
virtual elements called target elements located outside said virtual frame,
where the positions of the virtual target elements and the virtual fastening elements relatively to the corresponding virtual frames are computed so that the set of virtual target elements of a virtual image coincides on the three-dimensional model with virtual fastening elements of the adjacent virtual images, and so that the set of virtual fastening elements of a virtual image coincides on the three-dimensional model with virtual target elements of the adjacent virtual images;
b) it is calculated, for each virtual image, an orientation and a position of the laser source relatively to the surface for allowing the implementation of the etching of the patterns in accordance with the prior theoretical modelization;
c) it is etched a pattern called start pattern, based on a virtual image, of a so-called start orientation and position of the laser source based on computations of the steps a) and b), the start pattern having an etched frame covering an area called start area of the surface, etched target elements located outside the etched frame of the start pattern and hence outside said start area;
d) it is prepared the etching of a new pattern on a new area adjacent to said start area, by generating a new virtual image and by displacing and orienting the laser source in accordance with the computations of steps a) and b), some of the target elements of the start pattern being etched on said new area;
e) it is identified with the three-dimensional mapping system the positions of the target elements of the start pattern etched on said new area;
f) the projections are computed, in the image plane of the laser source, of the target elements of the start pattern etched on the new area;
g) it is applied, in the image plane, a geometric transformation on the new virtual image to make coincide:
said projections of the target elements of the start pattern, with
the virtual fastening elements of the new virtual image which were computed, during the step a), in order to coincide with virtual target elements of the virtual start image;
h) the new pattern is etched based on the new virtual image transformed during the step g), in such a manner that the new pattern has an etched frame covering the new area, etched fastening elements which coincide with the target elements of the start pattern etched on said new area, and etched target elements located outside the new area;
i) steps d) to h) are repeated for the following patterns in order to tessellate the surface with adjacent etched patterns.

2. The method according to claim 1, wherein, during computations of the step a), each virtual image is computed in such a manner that the virtual fastening elements thereof are localized on virtual texture elements of its virtual frame, said virtual texture elements defining the drawing of the virtual frame, so that, during step h), the target elements of the start pattern etched on the new area are etched on texture elements of the etched frame of the new pattern.

3. The method according to claim 1, further comprising, prior to step c), two calibration steps:
a first step of calibrating a three-dimensional mapping system in order to be able to determine the position in space of a point of the surface,
a second step of calibrating the laser source with respect to the three-dimensional mapping system in order to be able to establish the projection, in the image plane of the laser source, of a point of the surface detected by the three-dimensional mapping system.

4. The method according to claim 3, wherein the second calibration step consists in using the three-dimensional mapping system coupled to the laser source as follows:
it is etched on a planar surface, located at a first height, a plurality of calibration patterns based on a virtual image composed of a plurality of virtual calibration patterns distributed according to a given sizing, then it is determined with the three-dimensional mapping system the position of the calibration patterns etched on said planar surface;
the previous step is repeated on planar surfaces located at different heights with respect to said first height.

5. The method according to claim 1, wherein the method uses, as three-dimensional mapping system, at least one stereoscopic vision system comprising at least two cameras coupled to the laser source.

6. The method according to claim 3, wherein the first step of calibrating the stereoscopic vision system implements an intrinsic calibration and an extrinsic calibration of the at least two cameras, then a stereoscopic calibration for determining the relative position and orientation of the cameras.

7. The method according to claim 1, wherein the method uses, as three-dimensional mapping system, at least one system included in the following list: depth sensor, measuring system by projection of structured light fringes, measuring system by projection of laser fringes 3D camera.

8. The method according to claim 1, wherein, during computations of the step a), at least one virtual image includes a virtual frame called composite which is composed of a plurality of tessellation sub-elements gathered against each other.

9. The method according to claim 8, wherein the virtual composite frame is based on the gathering of several polygonal tessellation sub-elements of a planar shape, said tessellation sub-elements preferably being gathered in order to fill at the maximum the surface area of the image plane of the laser source.

10. The method according to claim 9, wherein the polygonal tessellation sub-elements are gathered according to a triangulation model using a criterion called chord error.

11. A system for marking a surface by laser treatment, suitable for implementing a marking method in accordance with claim 1, said system including:
a laser source provided with an image plane;
a three-dimensional mapping system coupled to the laser source;
a system for generating a virtual image in the image plane of the laser source, suitable for generating a virtual image;
an actuating system ensuring the displacement and orientation of the laser source and the three-dimensional mapping system;
a computation system designed to achieve the steps of computation a), b) and f), and apply the geometric transformation of the step g) on the new virtual image.

12. The method according to claim 2, further comprising, prior to step c), two calibration steps:
a first step of calibrating a three-dimensional mapping system in order to be able to determine the position in space of a point of the surface,
a second step of calibrating the laser source with respect to the three-dimensional mapping system in order to be able to establish the projection, in the image plane of the laser source, of a point of the surface detected by the three-dimensional mapping system.

13. The method according to claim 12, wherein the second calibration step consists in using the three-dimensional mapping system coupled to the laser source as follows:
it is etched on a planar surface, located at a first height, a plurality of calibration patterns based on a virtual image composed of a plurality of virtual calibration patterns distributed according to a given sizing, then it is determined with the three-dimensional mapping system the position of the calibration patterns etched on said planar surface;
the previous step is repeated on planar surfaces located at different heights with respect to said first height.

14. The method according to claim 13, wherein the method uses, as three-dimensional mapping system, at least one stereoscopic vision system comprising at least two cameras coupled to the laser source.

15. The method according to claim 14, wherein the first step of calibrating the stereoscopic vision system implements an intrinsic calibration and an extrinsic calibration of the at least two cameras, then a stereoscopic calibration for determining the relative position and orientation of the cameras.

16. The method according to claim 12, wherein the first step of calibrating the stereoscopic vision system implements an intrinsic calibration and an extrinsic calibration of the at least two cameras, then a stereoscopic calibration for determining the relative position and orientation of the cameras.

17. The method according to claim 15, wherein the method uses, as three-dimensional mapping system, at least one system included in the following list: depth sensor, measuring system by projection of structured light fringes, measuring system by projection of laser fringes 3D camera.

18. The method according to claim 17, wherein, during computations of the step a), at least one virtual image includes a virtual frame called composite which is composed of a plurality of tessellation sub-elements gathered against each other.

19. The method according to claim 15, wherein, during computations of the step a), at least one virtual image includes a virtual frame called composite which is composed of a plurality of tessellation sub-elements gathered against each other.

20. A system for marking a surface by laser treatment, suitable for implementing a marking method in accordance with claim 18, said system including:
a laser source provided with an image plane;
a three-dimensional mapping system coupled to the laser source;
a system for generating a virtual image in the image plane of the laser source, suitable for generating a virtual image;
an actuating system ensuring the displacement and orientation of the laser source and the three-dimensional mapping system;
a computation system designed to achieve the steps of computation a), b) and f), and apply the geometric transformation of the step g) on the new virtual image.
